(19) United States
(12) Patent Application Publication
(10) Pub. No.: US 2009/0047704 A1
(43) Pub. Date: Feb. 19, 2009

(54) Combination of a Histological or Cytological Fixing Agent and One or More Photoactivatable Compounds of the Quinone Family, In Particular Hypericin, Hypocrellin A and Hypocrellin B

(75) Inventor: Eric Peltier, Clamart (FR)

Correspondence Address: YOUNG & THOMPSON, 209 Madison Street, Suite 500, ALEXANDRIA, VA, 22314, US

(73) Assignee: NOVACYT, Velizy Villacoublay (FR)

(21) Appl. No.: 11/887,926

(22) PCT Filed: Apr. 7, 2006
(86) PCT No.: PCT/FR2006/000782

§ 371 Date: Oct. 5, 2007

(30) Foreign Application Priority Data
Apr. 7, 2005 (FR) 0503487

(51) Int. Cl. G01N 1/30

(52) U.S. Cl. 435/40.51; 435/40.52

(57) ABSTRACT

The invention relates to the combination, in solution or in a kit, of a histological or cytological fixing solution and of one or more photoactivatable compounds of the family of quinones, in particular, hypericin, hypocrellin A and/or hypocrellin B. The invention also relates to a method for labeling cells or tissues by one or more photoactivatable compounds of the family of quinones, in which the cells or tissues in contact with a histological or cytological fixing solution are labeled, simultaneously or subsequently, by the photoactivatable compound(s) of the family of quinones.

The invention relates to the combination, in a solution or in a kit, of a histological or cytological fixing agent and one or more photoactivatable compounds of the quinone family.

The invention also relates to a method for marking cells or tissues with one or more photoactivatable compounds of the quinone family wherein the cells or tissues placed in contact with a histological or cytological fixing agent are marked, simultaneously or afterwards, by the photoactivatable compound(s) of the quinone family.

Photoactivatable compounds of the quinone family include in particular polycyclic quinones, such as hypericin, hypocrellin A or hypocrellin B or derivatives thereof.

“Derivative” indicates a chemically modified compound in which the modification is considered to be routine by a chemist skilled in the art, such as an ester or an amide of an acid, protection groups, such as a benzyl group for an alcohol or a thiol, and a tert-butoxycarbonyl group for an amine.

Hypocrellin A (1H-Cyclohepta[ghi]perylene-5,11-dione, 1-acetyl-2,3-dihydro-2,6,12-trihydroxy-4,8,9,13-tetramethoxy-2-methyl-, cis-) and hypocrellin B (1H-cyclohepta[ghi]perylene-5,12-dione, 3-acetyl-6,11-dihydroxy-4,8,9,13-tetramethoxy-2-methyl) are quinones which are isolated from the fungi Hypocrella bambusae and Shiraia bambusicola.

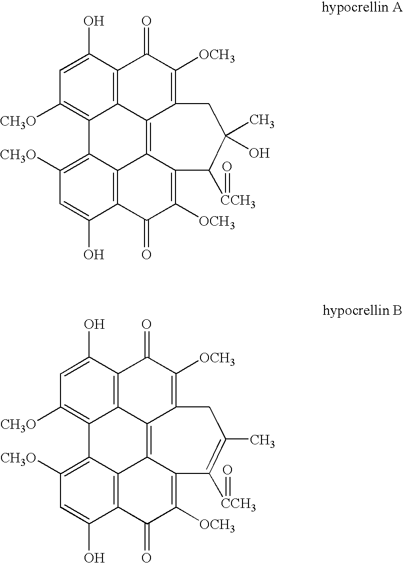

These pigments were used in combination with phototherapy for treatment of various illnesses of the skin. Recently, antiviral properties have been identified and it has been found that these quinones constitute powerful photosensitising agents in the photodynamic treatment of cancer (Hirayama et al., 1997; Zhang et al., 1998).

The maxima of fluorescence absorption and emission, measured in methanol, are 463 nm and 600 nm, respectively, for hypocrellin A and 459 nm and 616 nm for hypocrellin B.

Hypericin has the chemical formula 1,3,4,6,8,13-hexahydroxy-10,11-dimethylphenanthro(1,10,9,8,opqra)perylene-7,14-dione:

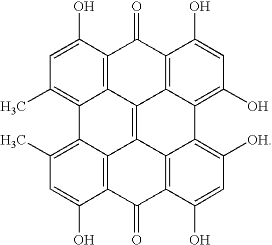

Hypericin is a natural pigment which is isolated from plants of the Hypericum genus, which constitutes a powerful selective inhibitor of protein kinase C.

Hypericin has a variety of pharmacological properties which range from an antibacterial or antiviral activity to an antineoplastic activity and the induction of apoptosis.

Hypericin has long been known for its photosensitising effects and as part of the composition of an antidepressant (Hypericum).

It is a fluorescent molecule which has a maximum level of absorption at 591 nm and a maximum emission of fluorescence at 594 nm, measured in ethanol.

It has been shown that hypericin perfused in the bladder accumulates selectively in carcinomatous urothelial cells. This feature, which is associated with its photosensitising and fluorescent properties, has led a number of teams to propose a diagnosis of cancer of the bladder using ex vivo fluorescent cytology (Olivo et al., 2003a; Olivo et al., 2003b; Pytel and Schmeller, 2002). The use of hypericin as a photodynamic treatment for carcinomatous lesions of the bladder has also been proposed (Kamuhabwa et al., 2004). These methods involve the in vivo infusion of hypericin in the bladder of the patient.

It is known that hypericin is a lipophilic molecule which can be incorporated in the lipid bilayer of cell membranes. The precise mechanisms for integration are not known but it is assumed that this integration involves active transport. Therefore, to date, hypericin has been used only on living cells.

Up to the present time, it was considered to be necessary to carry out a marking with hypericin on living cells, for example, by cultivating cells in vitro in a solution containing hypericin or by placing hypericin extemporaneously in contact with the cells or tissues which have recently been removed so that the hypericin can be incorporated by the living cells.

Against all expectations, the inventor has now shown that hypericin, mixed with a fixing agent, is incorporated very rapidly by tumorous cells which are placed in suspension in the fixing agent/hypericin admixture, even though the cells were killed by the contact with the fixing agent. The proof that hypericin is fixed equally efficiently by the cells, whether they are living or dead, affords new possibilities for cytological or histological marking using hypericin, and more generally using photoactivatable compounds of the quinone family.

The fixing is an operation which is intended to kill the cells in order to preserve them, to the greatest possible extent, in the state in which they were found when alive. With no fixing, there is a risk of autolysis. The best fixing agents are those which, whilst acting rapidly, produce the least possible secondary modifications or means which are likely to give a very false indication of the internal morphology of the cells.

Consequently, it is possible to study cells or tissues at any time, without being obliged to maintain them in a living state, by carrying out a marking operation using one or more photoactivatable compounds of the quinone family, in particular hypericin, at the same time as or following the fixing of the cells or tissues using a cytological or histological fixing agent.

Furthermore, it has been shown that, when tumorous cells are placed in suspension in a solution of fixing agent containing micromolar measures of hypericin, the affinity of the hypericin for the cells is such that almost all of the hypericin is incorporated by the cells. Since the liquid phase of the cell suspension practically no longer contains hypericin, it is possible to carry out a direct analysis of the cells (morphological and/or fluorescence emission analysis) without rinsing the cell suspension. This property therefore allows the cell/tissue preparation and the analysis of the cells to be automated.

The invention therefore relates to a solution comprising a histological or cytological fixing agent and one or more photoactivatable compounds of the quinone family. Preferably, the photoactivatable compound(s) of the quinone family is/are selected from the group constituted by hypericin, hypocrellin A and hypocrellin B. More preferably, the composition comprises, or is constituted by, a histological or cytological fixing agent and hypericin.

“Histological or cytological fixing agent” or “histological or cytological fixing solution” is intended to refer to a solution which is conventionally used in histological or cytological analysis in order to carry out the fixing of cells or tissues. Examples of cytological fixing agents include fixing agents based on ethyl alcohol, methyl alcohol, or polyethylene glycol (PEG). Examples of histological fixing agents include fixing agents based on formaldehyde, such as a solution of pure formol at 10% (“pure formol” corresponding to the aqueous solution of formaldehyde at 40%, generally commercially available under the name “formol”), a solution of formol/NaCl (constituted, for example, by mixing 10 ml of pure formol, 0.9 g of NaCl and 90 ml of water), a solution of formol/acetic acid (for example, 100 ml of pure formol, 50 ml of glacial acetic acid and 850 ml of water), alcoholic Bouin liquid (or Duboscq Brazil; for example, 250 ml of pure formol, 70 ml of glacial acetic acid, 5 g of picric acid and 680 ml of ethanol at 700). Other examples of fixing agents include the fixing agent alcohol/formol/acetic acid (20 ml of pure formol, 50 ml of glacial acetic acid, 750 ml of absolute ethyl alcohol, and 180 ml of water), or fixing agents based on zinc chloride (10% formol, 10-50 g/l of zinc chloride, and 5% acetic acid or NaCl 9 g/l, optionally 75% absolute alcohol).

The solution according to the invention advantageously comprises from 1 to 20 micromoles/ml, preferably from 1 to 15 micromoles/ml, preferably from 1 to 10 micromoles/ml, and more preferably from 1 to 2 micromoles/ml of photoactivatable compounds of the quinone family.

The invention also relates to a kit comprising a histological or cytological fixing agent and one or more photoactivatable compounds of the quinone family. Preferably, the photoactivatable compound(s) of the quinone family is/are selected from the group constituted by hypericin, hypocrellin A and hypocrellin B. More preferably, the kit according to the invention comprises a histological or cytological fixing agent and hypericin. The kit may optionally further comprise an appropriate washing buffer, directions for use or any other solution or appropriate device.

The invention also relates to a method for ex vivo marking of cells or a tissue using one or more photoactivatable compounds of the quinone family. The method comprises steps involving:

a) placing a sample of cells or tissue in contact with a histological or cytological fixing solution;
b) simultaneously or consecutively placing the sample of cells or tissue in contact with a solution comprising one or more photoactivatable compounds of the quinone family, for a length of time which is sufficient for the cells or the tissue to incorporate them; and
c) optionally washing the sample of cells or tissue.

Preferably, the solution comprising the photoactivatable compound(s) of the quinone family is the histological or cytological fixing solution. Steps a) and b) are implemented simultaneously. The fixing time of a cell suspension is very short (in the order of a few minutes) and that of the tissue sample is in the order of one hour. The incorporation of photoactivatable compounds of the quinone family, in particular hypericin, by cells in suspension generally takes from 1 to 2 hours. The difference between the time for incorporation of the photoactivatable compounds of the quinone family and the fixing time for the cells or tissues ensures that, according to the method of the invention, the photoactivatable compounds of the quinone family are incorporated when the cells have already been fixed, that is to say, are dead.

Preferably, the photoactivatable compound(s) of the quinone family is/are selected from the group which is constituted by hypericin, hypocrellin A and hypocrellin B. More preferably, the method is a method for ex vivo marking of cells or a tissue using hypericin.

The cells or the tissue are preferably cells which are tumorous or which are suspected of being tumorous. The sample of cells or tissue may thus be obtained by means of removal from or biopsy in a patient who is suspected of suffering from cancer and on whom it is desirable to show the presence of tumorous cells. The sample may also have been obtained from a patient in whom a cancer has been diagnosed and for whom the effectiveness of a therapeutic treatment is evaluated by measuring the development over time of the incorporation of hypericin by the cancerous cells.

The cells or tissue may be from any organ, for example, the uterus, the liver, the stomach, the lung, the oesophagus, the bladder, the prostate, breast, etcetera. A sample of cells may, for example, be a sample of liquid, such as urines, ascites, pleural or pericardic liquid; a smear, such as a cervical, vaginal, vulvar or oesophageal smear; a mammary discharge or puncture of an organ, for example, a superficial gland, such as the breast, the thyroid and the parotid or an deep-lying organ, such as the kidney, the liver, the ovaries, etcetera. A sample of tissue may be a biopsy or a complete or partial ablation of any organ.

The patient may be an animal, preferably a mammal, such as a human, a rodent, a dog or a cat. Preferably the patient is a human.

The invention also relates to the use of a solution comprising a histological and cytological fixing agent and one or more photoactivatable compounds from the quinone family in order to diagnose a cancer or a dysplasia, or to monitor the therapeutic effectiveness of a treatment or a cancer.

More specifically, the invention proposes a method for diagnosing a cancer or dysplasia wherein cells or a tissue are marked with one or more photoactivatable compounds of the quinone family according to the method described above and wherein the presence of cells or a tissue marked by the photoactivatable compound(s) of the quinone family indicates the presence of tumorous or dysplastic cells. Preferably, the photoactivatable compound(s) of the quinone family is/are selected from the group constituted by hypericin, hypocrellin A and hypocrellin B.

According to one embodiment, the method for diagnosing a cancer or dysplasia comprises the steps involving:

a) placing a sample of cells or tissue in contact with a histological or cytological fixing solution;
b) simultaneously or consecutively placing the sample of cells or tissue in contact with a solution comprising hypericin, for a length of time which is sufficient for the cells or the tissue to incorporate the hypericin;
c) optionally washing the sample of cells or tissue; and
d) detecting the presence of cells or tissue marked with hypericin;
wherein the presence of cells or tissue marked with hypericin indicates the presence of a cancer or a dysplasia.

The detection of a marking of the cells or tissue using photoactivatable compounds from the quinone family can be readily carried out by measuring the fluorescence emitted by the cells or the tissue, in particular in the region of 600 nm for hypericin, hypocrellin A or hypocrellin B.

The results indicate that hypericin has a great affinity for specific tumorous cells with a preferential perinuclear localisation, whilst normal cells show only a very low level of affinity for a peripheral localisation in the region of the cell membrane.

Therefore, according to an embodiment of the invention, at least step d), and preferably all the steps, are implemented in an automated manner, thus allowing automatic screening of samples.

Preferably, perinuclear marking of the cells is detected.

The invention is illustrated in greater detail in the following non-limiting examples.

### EXAMPLES

### Example 1

Human glioblastoma cells are cultivated in a petri dish.

Hypericin is placed in suspension in a solution of Sakomano cytological fixing agent, with a concentration of 2 micromoles per ml, four hours before the experiments. The fixing agent solution comprising hypericin is shielded from light.

The cells of the glioblastoma are directly fixed by placing them in the solution of fixing agent prepared based on hypericin for one hour.

Comparative tests are carried out using a microspectrofluorometer in order to compare the level of intensity of fluorescence and the quality of the fluorescence spectrum measured in cultures of identical living glioblastoma cells, incubated at the same concentration for one hour in the solution of Sakomano cytological fixing agent containing hypericin, and the fixed cells.

The results show that the spectrums can be completely superimposed and that the levels of intensity of the fluorescence are identical between the cells which are still living and the fixed cells.

### Example 2

Cells from a line of epidermoid malphigian carcinoma of the cervix, of the type HeLa, are cultivated in a petri dish. They are then fixed in a cytological fixing agent of the Sakomano type which already includes normal epithelial cells from a cervical smear in order to verify the affinity of hypericin for the tumorous cells in a cell suspension containing several types of normal cells and tumorous cells.

Hypericin is then placed in suspension for one hour in the cell suspension fixed at a concentration of 2 μm/ml and shielded from light.

Tests are carried out using a microspectrofluorometer in order to compare the level of intensity of fluorescence and the quality of the fluorescence spectrum measured for the different cells of the suspension, incubated at the same concentration for one hour in the solution of Sakomano cytological fixing agent containing hypericin.

The results show that hypericin has a great affinity for tumorous HeLa cells with a very specific preferential perinuclear localisation, whilst the normal cells show only a low level of affinity for a peripheral localisation in the region of the cell membrane.

The cells which thus have specific marking may be detected using automatic recognition means. Therefore, it is possible to envisage automatic screening of the cytological samples and in particular of the cervical smear in order to select only the pathological cell distributions.

### REFERENCES

Hirayama J., et al. (1997) Photoinactivation of virus infectivity by hypocrellin A; Photochem. Photobiol. 66, 697
Kamuhabwa A, Agostinis P, Ahmed B, Landuyt W, van Cleynenbreugel B, van Poppel H, de Witte P. (2004) Hypericin as a potential phototherapeutic agent in superficial transitional cell carcinoma of the bladder. Photochem Photobiol Sci.; 3(8):772-80. Epub 2004 Apr. 2.
Olivo M, Lau W, Manivasager V, Bhuvaneswari R, Wei Z, Soo K C, Cheng C, Tan P H. (2003b) Novel photodynamic diagnosis of bladder cancer: ex vivo fluorescence cytology using hypericin. Int J. Oncol.; 23(6):1501-4.
Olivo M, Lau W, Manivasager V, Tan P H, Soo K C, Cheng C. (2003a) Macro-microscopic fluorescence of human bladder cancer using hypericin fluorescence cystoscopy and laser confocal microscopy. Int J. Oncol.; 23(4):983-90.
Pytel A, Schmeller N. (2002) New aspect of photodynamic diagnosis of bladder tumors: fluorescence cytology. Urology.; 59(2):216-9.
Zhang J., et al.; (1998) Photodynamic effects of hypocrellin A on three human malignant cell lines by inducing apoptotic cell death J. Photochem. Photobiol. B. 43, 106

1. Solution for marking cells or tissues comprising a histological or cytological fixing agent and one or more photoactivatable compounds of the quinone family selected from the group constituted by hypericin, hypocrellin A and hypocrellin B.

2. Solution according to claim 1, comprising from 1 to 20 micromoles/ml of photoactivatable compounds of the quinone family.

3. Solution according to claim 1, comprising a histological or cytological fixing agent and hypericin.

4. Kit comprising a histological or cytological fixing agent and one or more photoactivatable compounds of the quinone family, selected from the group constituted by hypericin, hypocrellin A and hypocrellin B.

5. Kit according to claim 4, comprising a histological or cytological fixing agent and hypericin.

6. Method for ex vivo marking of cells or a tissue using one or more photoactivatable compounds of the quinone family, the method comprising the steps involving:
a) placing a sample of cells or tissue in contact with a histological or cytological fixing solution;
b) simultaneously or consecutively placing the sample of cells or tissue in contact with a solution comprising one or more photoactivatable compounds of the quinone family, selected from the group constituted by hypericin, hypocrellin A and hypocrellin B for a length of time which is sufficient for the cells or the tissue to incorporate the photoactivatable compound(s) of the quinone family;
c) optionally washing the sample of cells or tissue.

7. Method according to claim 6, wherein the solution comprising one or more photoactivatable compounds of the quinone family is the histological or cytological fixing solution and steps a) and b) are implemented simultaneously.

8. Method according to claim 6, wherein cells or a tissue are marked with hypericin.

9. Method according to claim 6, wherein the sample of cells or tissue originates from a patient suspected of suffering from a cancer.

10. Method according to claim 6, wherein the sample of cells is a sample of liquid, a smear, a mammary discharge, or an organ puncture.

11. Method according to claim 6, wherein the tissue sample is a biopsy or a complete or partial ablation of an organ.

12. Use of a solution according to claim 1, for the in vitro diagnosis of a cancer or a dysplasia, or to monitor the therapeutic effectiveness of a cancer treatment.

13. Method for in vitro diagnosis of a cancer or a dysplasia, comprising the steps involving:
a) placing a sample of cells or tissue in contact with a histological or cytological fixing solution;
b) simultaneously or consecutively placing the sample of cells or tissue in contact with a solution comprising one or more photoactivatable compounds of the quinone family selected from the group constituted by hypericin, hypocrellin A and hypocrellin B, for a length of time which is sufficient for the cells or the tissue to incorporate the photoactivatable compound(s) of the quinone family;
c) optionally washing the sample of cells or tissue; and
d) detecting the presence of cells or tissue marked with the photoactivatable compound(s) of the quinone family;
wherein the presence of cells or tissue marked with the photoactivatable compound(s) of the quinone family indicates the presence of a cancer or a dysplasia.

14. Method for in vitro diagnosis of a cancer or a dysplasia according to claim 13, comprising the steps involving:
a) placing a sample of cells or tissue in contact with a histological or cytological fixing solution;
b) simultaneously or consecutively placing the sample of cells or tissue in contact with a solution comprising hypericin, for a length of time which is sufficient for the cells or the tissue to incorporate the hypericin;
c) optionally washing the sample of cells or tissue; and
d) detecting the presence of cells or tissue marked with hypericin;
wherein the presence of cells or tissue marked with hypericin indicates the presence of a cancer or a dysplasia.

15. Method according to claim 13, wherein at least step d) is carried out in an automated manner.

16. Method according to claim 13, wherein a perinuclear marking is detected.

17. Method according to claim 14, wherein at least step d) is carried out in an automated manner.

18. Solution according to claim 2, comprising a histological or cytological fixing agent and hypericin.

19. Method according to claim 7, wherein cells or a tissue are marked with hypericin.

20. Method according to claim 7, wherein the sample of cells or tissue originates from a patient suspected of suffering from a cancer.
